(19) United States
(12) Patent Application Publication
(10) Pub. No.: US 2024/0311628 A1
(43) Pub. Date: Sep. 19, 2024

(54) LIRIC Diffractive Deep Neural Network

(71) Applicant: Clerio Vision, Inc., Rochester, NY (US)

(72) Inventors: Filipp Ignatovich, Pittsford, NY (US); Leonard Zheleznyak, Pittsford, NY (US)

(73) Assignee: Clerio Vision, Inc., Rochester, NY (US)

(21) Appl. No.: 18/604,226

(22) Filed: Mar. 13, 2024

Related U.S. Application Data
(60) Provisional application No. 63/451,870, filed on Mar. 13, 2023.

(51) Int. Cl. G06N 3/067; G06N 3/049

(52) U.S. Cl. CPC G06N 3/067; G06N 3/049

(57) ABSTRACT

Optical elements for diffractive deep neural networks include one or more subsurface layers of diffractive optical elements. An optical element for a diffractive deep neural network includes a substrate and one or more subsurface layers of diffractive optical elements formed within the substrate. The substrate is made from an optical material having a base refractive index. Each of the one or more subsurface layers includes a respective subset of the diffractive optical elements. Each of the diffractive optical elements is formed within a respective sub-volume of the respective subsurface layer via induced changes in refractive index of the optical material to configure the diffractive optical element to function as a neuron in the diffractive deep neural network.

### CROSS REFERENCE TO RELATED APPLICATION DATA

The present application claims the benefit under 35 USC § 119(e) of U.S. Provisional Appln. No. 63/451,870 filed Mar. 13, 2023; the full disclosure which is incorporated herein by reference in its entirety for all purposes.

### BACKGROUND

Diffractive deep neural networks (DDNN) can include transmissive and/or reflective layers. Each layer can include an array of diffractive optical elements (DOEs) configured to function as optical neurons that redirect a light wave onto the optical neurons in the next layer. As illustrated in FIG. 1, each DOE 12 acts as a secondary source of a light wave having an amplitude and phase determined by the product of the input light wave and the complex valued transmission of reflection coefficient of the DOE 12. DDNNs have been proposed for use in performing image classification tasks (see, e.g., Lin X, Rivenson Y, Yardimci N T, Veli M, Luo Y, Jarrahi M, et al. All-optical machine learning using diffractive deep neural networks. Science. 2018; 361(6406):1004-8) and in high-resolution image projection (see, e.g., Işil ç, Mengu D, Zhao Y, Tabassum A, Li J, Luo Y, et al. Super-resolution image display using diffractive decoders. Science Advances. 2022; 8(48):eadd3433).

Fabrication of DOEs for a DDNN can be done with 3-printing (e.g., as described in Lin X, Rivenson Y, Yardimci N T, Veli M, Luo Y, Jarrahi M, et al. All-optical machine learning using diffractive deep neural networks. Science. 2018; 361(6406):1004-8), femtosecond laser nanolithography (e.g., as described in Yan T, Wu J, Zhou T, Xie H, Xu F, Fan J, et al. Fourier-space diffractive deep neural network. Physical review letters.

2019; 123(2):023901, and lithographic micro-etching in silicon oxide wafers (e.g., as described in Chen H, Feng J, Jiang M, Wang Y, Lin J, Tan J, et al. Diffractive deep neural networks at visible wavelengths. Engineering. 2021; 7(10):1483-91).

Existing methods approaches for fabricating DDNNs rely on producing physical diffractive patterns on the surface of an optical material. Such existing approaches suffer from number of drawbacks arising primarily from difficulties in accurately aligning and combining multiple substrates and patterns with respect to each other within a limited volume.

### BRIEF SUMMARY

The following presents a simplified summary of some embodiments of the invention to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In many embodiments, a DDNN includes an optical substrate that includes one or more subsurface layers of diffractive optical elements (DOEs). The optical substrate is formed from an optical material having an initial (or “base”) refractive index. Each subsurface DOE consists of a respective sub-volume of the optical substrate having an induced distribution of refractive indexes (i.e., changes in refractive indexes relative to the initial or base refractive index). The changes in refractive index can be induced using any suitable approach, such as via a laser as described in U.S. Patent Publication No. 2023-0204978, the entire contents of which are hereby incorporated by reference. The optical substrate can be employed in any suitable application. For example, the optical substrate can be any employed in any suitable ophthalmic application such as a contact lens, a spectacle lens, a head worn display (e.g., an augmented reality display, a virtual reality display). Advantages relative to existing approaches for forming a DDNN include:
(1) the ability to achieve high lateral resolution, which enables usage of the DDNN with shorter wavelengths of light (including visible light and/or near infrared light) relative to a DDNN created via 3-D printing;
(2) the ability to achieve high axial resolution—each subsurface layer of DOEs can have a thickness in the range of 1 micrometer to 1 mm, thereby enabling multiple layers of DOEs to be formed within a single optical element; and
(3) the ability to precisely form the DOEs, thereby enabling more precise alignment of the layers of DOEs.

Thus, in one aspect, a diffractive deep neural network (DDNN) component includes a substrate and one or more subsurface layers of diffractive optical elements formed within the substrate. The substrate is formed from an optical material having a base refractive index. Each of the one or more subsurface layers of diffractive optical elements includes a respective subset of the diffractive optical elements. Each of the diffractive optical elements is formed within a respective sub-volume of the respective subsurface layer of diffractive optical elements via induced changes in refractive index of the optical material to configure the diffractive optical element to function as a neuron in the DDNN component.

The DDNN component can be configured to have a fine resolution. For example, in many embodiments, the DDNN component has a resolution of 0.01 mm or less. In some embodiments, the DDNN component has a resolution of 0.005 mm or less.

The DDNN component can be configured to process visible light and/or near infrared light. For example, the DDNN component can be configured to process at least one wavelength in a range from 380 nm to 750 nm. The DDNN component can be configured to process at least one wavelength in a range from 760 nm to 1500 nm.

The DDNN component can have any suitable number of subsurface layers of diffractive optical elements. For example, the DDNN component can have 1, 2, 3, 4, 5, 6, 7, 8, 9, 10, or more subsurface layers of diffractive optical elements.

The DDNN component can be employed in any suitable application. For example, a contact lens can include the DDNN component. A spectacle lens can include the DDNN component. A head worn augmented reality display can include the DDNN component. A head worn virtual reality display can include the DDNN component.

In another aspect, an image classification system includes a diffractive deep neural network (DDNN) component, an image sensor, and a processing unit. The DDNN component includes a substrate and one or more subsurface layers of diffractive optical elements formed within the substrate. The substrate is formed from an optical material having a base refractive index. Each of the one or more subsurface layers of diffractive optical elements includes a respective subset of the diffractive optical elements. Each of the diffractive optical elements is formed within a respective sub-volume of the respective subsurface layer via induced changes in refractive index of the optical material to configure the diffractive optical element to function as a neuron in a diffractive deep neural network. The image sensor is aligned with an output plane of the DDNN component. The image sensor is configured to generate an image sensor output indicative of a distribution and intensity of light output from the DDNN component onto the image sensor. The processing unit is configured to process the image sensor output to classify an image processed by the DDNN component. In many embodiments, the processing unit includes at least one processor and a tangible memory device storing non-transient instructions executable by the at least one processor to cause the at least one processor to process the sensor output to classify an image processed by the DDNN component.

The image classification system can be configured to have a fine resolution. For example, in many embodiments, the image classification system has a resolution of 0.01 mm or less. In some embodiments, the image classification system has a resolution of 0.005 mm or less.

The image classification system can be configured to process visible light and/or near infrared light. For example, the image classification system DDNN component can be configured to process at least one wavelength in a range from 380 nm to 750 nm. The image classification system DDNN component can be configured to process at least one wavelength in a range from 760 nm to 1500 nm.

The image classification system DDNN component can have any suitable number of subsurface layers of diffractive optical elements. For example, the image classification system DDNN component can have 1, 2, 3, 4, 5, 6, 7, 8, 9, 10, or more subsurface layers of diffractive optical elements.

In another aspect, a method of producing a diffractive deep neural network (DDNN) component is provided. The method includes: (a) receiving definition of optical alterations to be induced by diffractive optical elements configured to function as neurons in the DDNN component; (b) determining changes in refractive index of sub-volumes of a substrate made from an optical material for forming the diffractive optical elements within the substrate; (c) determining parameters for energy pulses for inducing the changes in refractive index of the sub-volumes of the substrate; and (d) directing the energy pulses into the substrate to form the diffractive optical elements within the substrate. The diffractive optical elements are arranged in one or more subsurface layers within the substrate. The substrate has an input surface via which coherent light forming an input image is received by the DDNN component. The substrate has an output surface via which processed light is output from the DDNN component.

The diffractive optical can be formed in any suitable order. For example, the one or more subsurface layers of the diffractive optical elements can be formed sequentially from the layer closest to the output surface to the layer closest to the input surface or from the layer closest to the input surface to the layer closest to the output surface. The one or more subsurface layers of the diffractive optical elements can be formed in two directions via directing a first subset of the energy pulses through the input surface to form a first set of the one or more subsurface layers sequentially towards the input surface and directing a second subset of the energy pulses through the output surface to form a second set of the one or more subsurface layers sequentially towards the output surface. In many embodiments, the substrate has one or more side surfaces that extend from the input surface to the output surface. The one or more subsurface layers can be formed via directing the energy pulses through at least one of the one or more side surfaces.

The DDNN component produced by the method can be configured to have a fine resolution. For example, in many embodiments, the DDNN component produced by the method has a resolution of 0.01 mm or less. In some embodiments, the DDNN component produced by the method has a resolution of 0.005 mm or less.

The DDNN component produced by the method can be configured to process visible light and/or near infrared light. For example, the DDNN component produced by the method can be configured to process at least one wavelength in a range from 380 nm to 750 nm. The DDNN component produced by the method can be configured to process at least one wavelength in a range from 760 nm to 1500 nm.

The DDNN component produced by the method can have any suitable number of subsurface layers of diffractive optical elements. For example, the DDNN component produced by the method can have 1, 2, 3, 4, 5, 6, 7, 8, 9, 10, or more subsurface layers of diffractive optical elements.

In another aspect, a system for producing a diffractive deep neural network (DDNN) component includes a laser beam pulse source, a power control assembly, a scanning assembly, and one or more controllers. The laser beam pulse source is operable to emit a sequence of laser beam pulses. The power control assembly is operable to control a pulse power of each of the sequence of laser beam pulses. The scanning assembly operable to scan the sequence of laser beam pulses to designated focal positions within a substrate formed from an optical material. The one or more controllers are configured to control operation of the power control assembly and the scanning assembly to direct the laser beam pulses into the substrate to form diffractive optical elements within the substrate. The diffractive optical elements are configured to function as neurons in the DDNN component. The diffractive optical elements are arranged in one or more subsurface layers within the substrate. The substrate has an input surface via which coherent light forming an input image is received by the DDNN component. The substrate has an output surface via which processed light is output from the DDNN component.

The DDNN component produced by the system can be configured to have a fine resolution. For example, in many embodiments, the DDNN component produced by the system has a resolution of 0.01 mm or less. In some embodiments, the DDNN component produced by the system has a resolution of 0.005 mm or less.

The DDNN component produced by the system can be configured to process visible light and/or near infrared light. For example, the DDNN component produced by the system can be configured to process at least one wavelength in a range from 380 nm to 750 nm. The DDNN component produced by the system can be configured to process at least one wavelength in a range from 760 nm to 1500 nm.

The DDNN component produced by the system can have any suitable number of subsurface layers of diffractive optical elements. For example, the DDNN component produced by the system can have 1, 2, 3, 4, 5, 6, 7, 8, 9, 10, or more subsurface layers of diffractive optical elements.

For a fuller understanding of the nature and advantages of the present invention, reference should be made to the ensuing detailed description and accompanying drawings.

### BRIEF DESCRIPTION OF THE DRAWINGS

FIG. 1 illustrates a diffractive deep neural network (DDNN).

FIG. 2 illustrates an existing configuration for a DDNN.

FIG. 3 and FIG. 4 illustrate an existing implementation of a DDNN.

FIG. 5 illustrates a DDNN that employs one or more subsurface layers of diffractive optical elements (DOEs) formed within a substrate via induced subsurface changes in refractive index, in accordance with many embodiments.

FIG. 6 schematically illustrates a system for producing a DDNN component, in accordance with embodiments.

FIG. 7 is a simplified block diagram illustrating a method of producing a DDNN component, in accordance with embodiments.

### DETAILED DESCRIPTION

In the description herein, various embodiments are described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

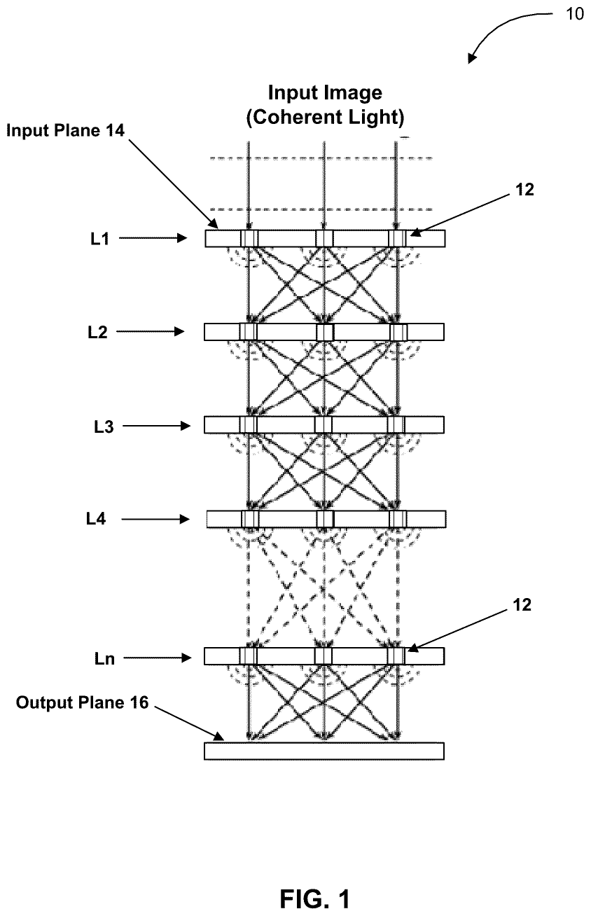

Turning now to the drawing figures in which similar reference identifies refer to similar elements, FIG. 1 illustrates functional aspects of a diffractive deep neural network (DDNN) 10. The DDNN 10 includes multiple layers (L1 through Ln) of diffractive optical elements (DOEs) 12. Each of the DOEs 12 is configured to act as the optical equivalent of a neuron in a traditional non-optical neural network. Each of the DOEs 12 is configured to transmit and/or reflect incoming light in accordance with a design complex-valued transmission (or reflection) coefficient for the DOE 12. The design transmission/reflection coefficients for the DOEs 12 can be determined using existing deep learning approaches to configure the DDNN 10 to perform a desired function (e.g., image classification, high-resolution image projection). In the illustrated embodiment, the DDNN 10 is configured to receive a coherent light input image at an input plane 14 and output a resulting output image onto an output plane 16. Each DOE 12 acts as a secondary source of a light wave having an amplitude and phase determined by the product of the input light wave and the design complex valued transmission of reflection coefficient of the DOE 12.

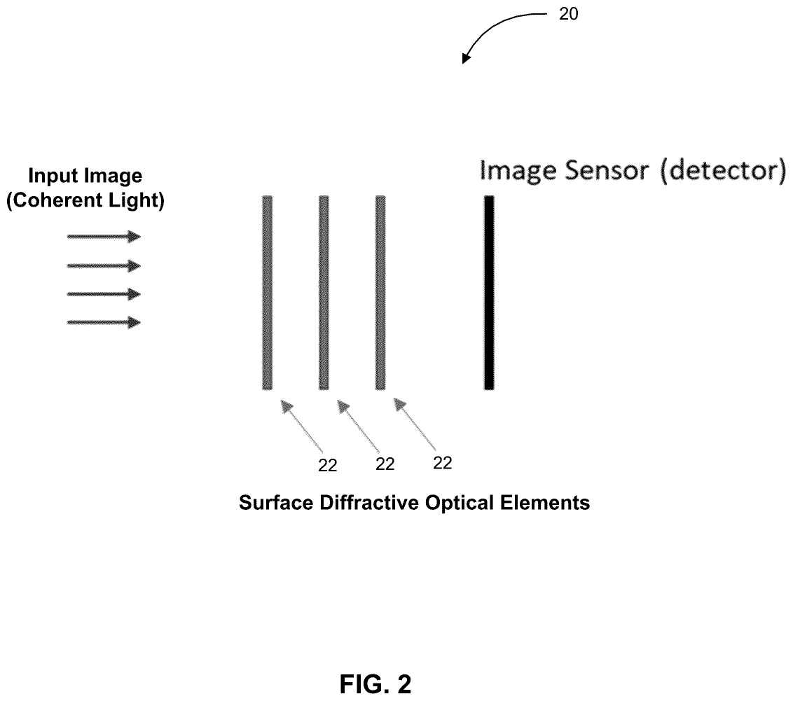

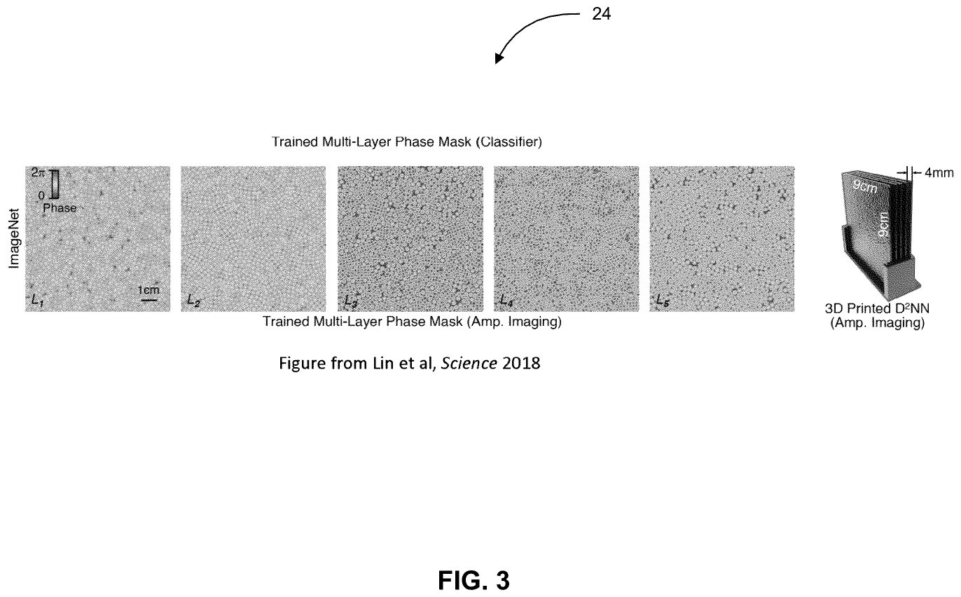

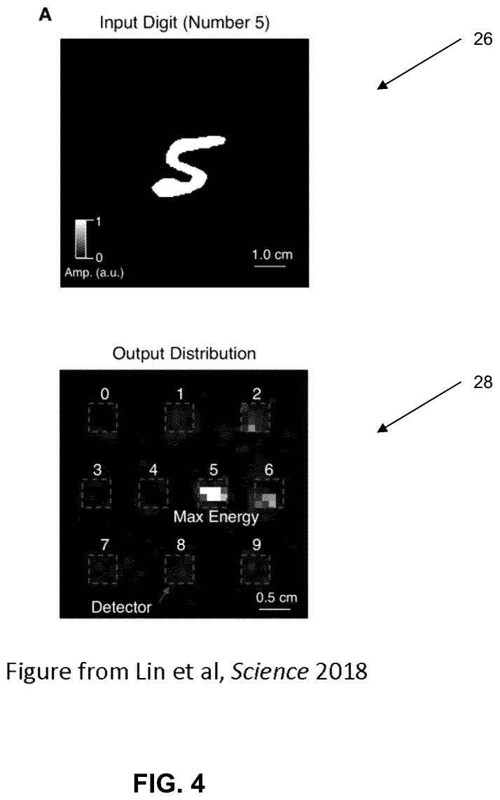

FIG. 2 illustrates an existing configuration for a DDNN 20, which includes separate substrates 22. Each of the substrates 22 includes a single layer of diffractive optical elements formed on the surface of the substrate 22 using any suitable existing approach (e.g., 3-printing (i.e. additive manufacturing), femtosecond laser nanolithography, and lithographic micro-etching in silicon oxide wafers). The feature size of 3-D printing is limited to millimeter range, which limits the laser wavelength usable for the DDNN 20 to the terahertz regime. For embodiments of the DDNN 20 configured for use in the visible spectrum, femtosecond nanolithography and lithographic micro-etching have been used, due to their micron scale resolution. Existing methods approaches for fabricating the DDNN 20 relies on producing physical diffractive patterns on the surface of an optical material. FIG. 3 illustrates an example trained multi-layer phase mask 24 for an image classification task (see, Lin X, Rivenson Y, Yardimci N T, Veli M, Luo Y, Jarrahi M, et al. All-optical machine learning using diffractive deep neural networks. Science. 2018; 361(6406):1004-8). FIG. 4 illustrates an example input image 26 to the phase mask 24 and a resulting output distribution 28. Existing configurations for DDNNs, however, suffer from number of drawbacks arising primarily from difficulties in accurately aligning and combining multiple substrates and patterns with respect to each other within a limited volume. These drawbacks lead to significant fabrication costs, limitations on the number of diffractive layers, and/or limitations on minimum feature size, thus limiting the practical processing capabilities of the resulting DDNN 20.

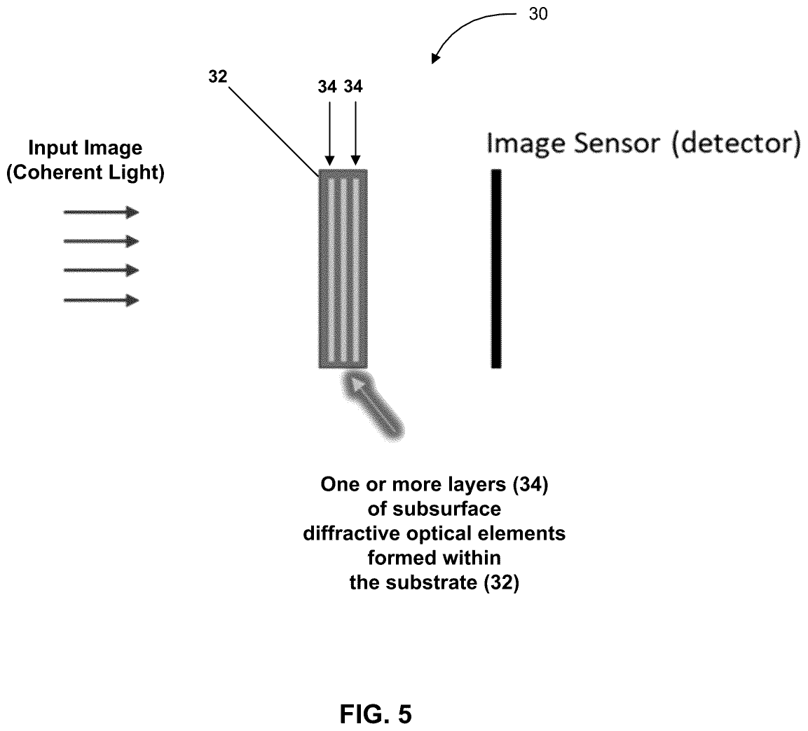

FIG. 5 illustrates a DDNN 30 that includes an optical substrate 32 that includes one or more subsurface layers 34 of diffractive optical elements (DOEs). Any suitable number of the subsurface layers 34 can be employed (e.g., 1, 2, 3, 4, 5, 6, 7, 8, 9, 10 or more). The optical substrate 32 is formed from an optical material having an initial (or “base”) refractive index. Each subsurface DOE consists of a respective sub-volume of the optical substrate 32 having an induced distribution of refractive indexes (i.e., changes in refractive indexes relative to the initial or base refractive index). The changes in refractive index can be induced using any suitable approach, such as via a laser as described in U.S. Patent Publication No. 2023-0204978, the full disclosure of which is hereby incorporated herein in its entirety for all purposes. The DOEs are configured to be functionally equivalent to the DOEs 12 of the DDNN 10 as described herein. Lateral resolution of DOEs in each layer can be below 1 micrometer. For example, when a 513 nm wavelength femtosecond laser and a numerical aperture of 0.6 are used to form the DOEs, the diameter of a diffraction-limited spot size (Airy disk) is ˜1 um. In some embodiments, the process used to induce the refractive index variations by which the DOEs are formed is a nonlinear multiphoton process so the achievable resolution of the DOEs can be smaller than the diffraction limited spot. The substrate 32 can be formed from any suitable material in which subsurface refractive index changes can be induced, such as any suitable hydrogel, plastic, glass or any other such material.

The DDNN 30 can be employed in any suitable application. For example, the DDNN 30 can be employed as a means of encoding high resolution information with a low-resolution display (see, e.g., Işil C, Mengu D, Zhao Y, Tabassum A, Li J, Luo Y, et al. Super-resolution image display using diffractive decoders. Science Advances. 2022; 8(48):cadd3433). As another example, the DDNN 30 can be incorporated into a contact lens to be worn on-eye and used in conjunction with a display. The DDNN 30 can be configured (via training) to convert a low resolution output of the display to a higher resolution version, to be seen by the eye wearing contact lens including the DDNN 30.

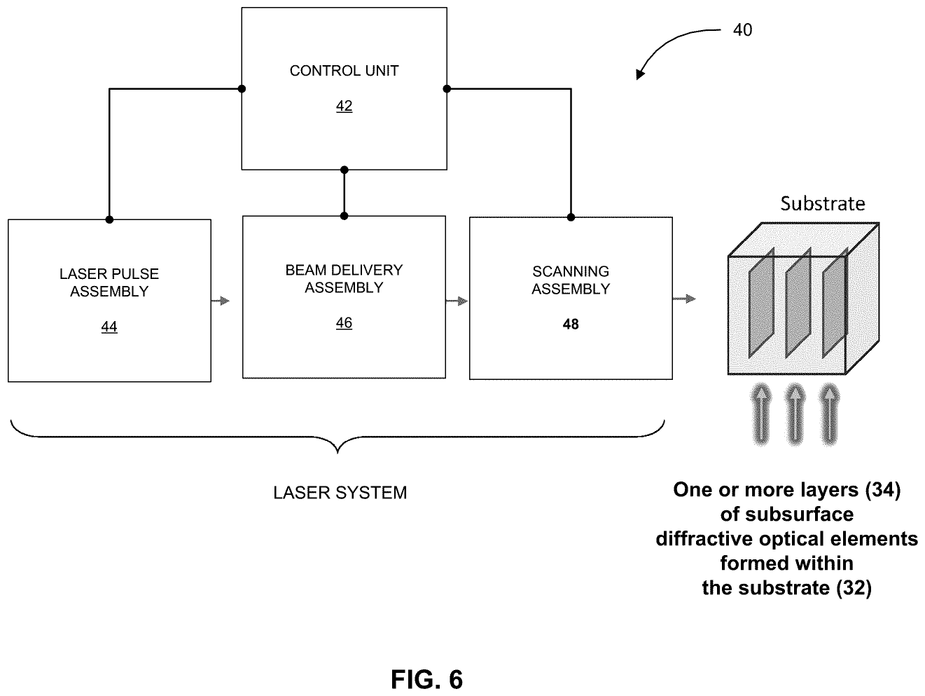

FIG. 6 schematically illustrates a system 40 for producing a DDNN component, in accordance with embodiments. The system 40 includes a control unit 42, a laser pulse assembly 44, a beam delivery assembly 46, and a scanning assembly 48. The control unit 42 is controllably connected to each of the laser pulse assembly 44, the beam delivery assembly 46, and the scanning assembly 48 and configured to control these assemblies for the generation and delivery of laser pulses into an optical substrate 32 for forming one or more layers of diffractive optical elements configured to function as neurons in a DDNN. Any suitable system can be used for producing a DDNN component, such as, for example, the systems described in U.S. Patent Publication No. 2024-0009766, the full disclosure of which is hereby incorporated herein in its entirety for all purposes.

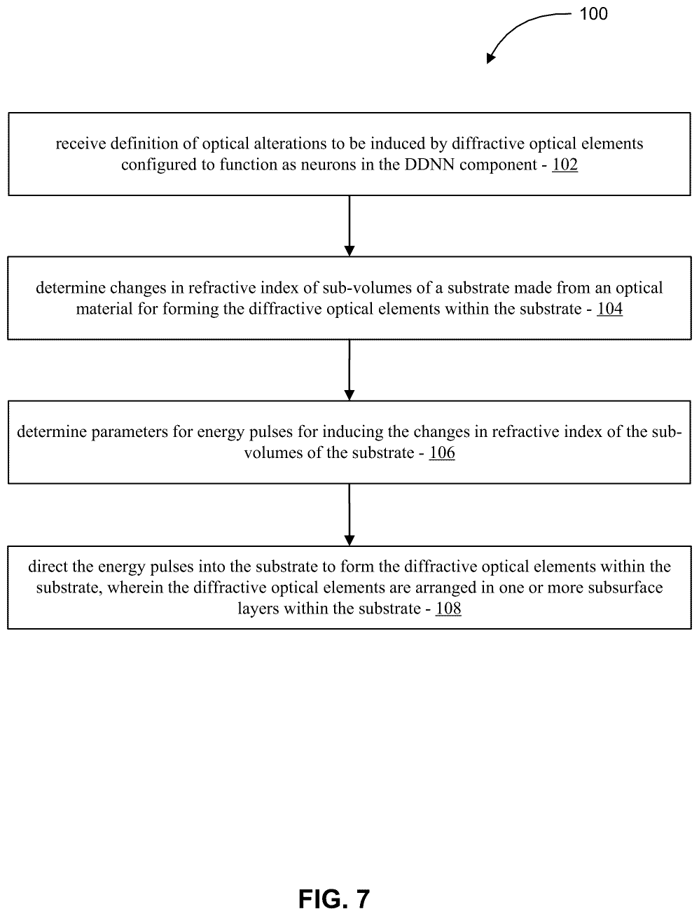

FIG. 7 is a simplified block diagram illustrating a method 100 of producing a DDNN component, in accordance with embodiments. Any suitable systems, such as those described herein, can be used to practice the method 100. In act 102, definitions of optical alterations to be induced by each of the diffractive optical elements (which are configured to function as neurons in the DDNN component) are received. Any suitable existing approach can be used to generate the definitions of the optical alterations to be induced by each of the diffractive optical elements. In act 104, changes in refractive index of sub-volumes of the substrate are determined (based on the definitions of the optical alterations) for forming the subsurface diffractive optical elements within the substrate. Any suitable approach can be used to determine the changes in the refractive index of sub-volumes of the substrate, such as, for example, the approaches described in U.S. Patent Publication No. 2021-0378508, the full disclosure of which is hereby incorporated herein in its entirety for all purposes. In act 106, parameters for energy pulses for inducing the changes in refractive index of the sub-volumes of the substrate are determined. Any suitable approach can be used for determining the parameters such as, for example, the approaches described in U.S. Patent Publication No. 2023-0032944, the full disclosure of which is hereby incorporated herein in its entirety for all purposes. In act 108, the energy pulses are directed into the substrate to form the diffractive optical elements within the substrate. In many embodiments, the diffractive optical elements are formed in one or more layers within the substrate in accordance with the desired configuration of the DDNN component.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention, and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A diffractive deep neural network (DDNN) component comprising:
a substrate formed from an optical material having a base refractive index; and
one or more subsurface layers of diffractive optical elements formed within the substrate, wherein each of the one or more subsurface layers of diffractive optical elements comprises a respective subset of the diffractive optical elements, wherein each of the diffractive optical elements is formed within a respective sub-volume of the respective subsurface layer of diffractive optical elements via induced changes in refractive index of the optical material to configured the diffractive optical element to function as a neuron in the DDNN component.

2. The DDNN component of claim 1 having a resolution of 0.01 mm or less.

3. The DDNN component of claim 2 having a resolution of 0.005 mm or less.

4. The DDNN component of claim 1 configured to process at least one wavelength in a range from 380 nm to 750 nm.

5. The DDNN component of claim 1 configured to process at least one wavelength in a range from 760 nm to 1500 nm.

6. The DDNN component of claim 1, wherein the substrate comprises 3 of the subsurface layers of diffractive optical elements.

7. A contact lens comprising the DDNN component of claim 1.

8. A spectacle lens comprising the DDNN component of claim 1.

9. A head worn augmented reality display comprising the DDNN component of claim 1.

10. A head worn virtual reality display comprising the DDNN component of claim 1.

11. A method of producing a diffractive deep neural network (DDNN) component, the method comprising:
receiving definition of optical alterations to be induced by diffractive optical elements configured to function as neurons in the DDNN component;
determining changes in refractive index of sub-volumes of a substrate made from an optical material for forming the diffractive optical elements within the substrate;
determining parameters for energy pulses for inducing the changes in refractive index of the sub-volumes of the substrate; and
directing the energy pulses into the substrate to form the diffractive optical elements within the substrate, wherein the diffractive optical elements are arranged in one or more subsurface layers within the substrate, wherein the substrate has an input surface via which coherent light forming an input image is received by the DDNN component, and wherein the substrate has an output surface via which processed light is output from the DDNN component.

12. The method of claim 11, wherein the one or more subsurface layers are formed sequentially from the layer closest to the output surface to the layer closest to the input surface or from the layer closest to the input surface to the layer closest to the output surface.

13. The method of claim 11, wherein the one or more subsurface layers are formed in two directions via directing a first subset of the energy pulses through the input surface to form a first set of the one or more subsurface layers sequentially towards the input surface and directing a second subset of the energy pulses through the output surface to form a second set of the one or more subsurface layers sequentially towards the output surface.

14. The method of claim 11, wherein:
the substrate has one or more side surfaces that extend from the input surface to the output surface; and
the one or more subsurface layers are formed via directing the energy pulses through at least one of the one or more side surfaces.

15. The method of claim 11, wherein the DDNN component has a resolution of 0.01 mm or less.

16. The method of claim 11, wherein the DDNN component has a resolution of 0.005 mm or less.

17. The method of claim 11, wherein the DDNN component is configured to process at least one wavelength in a range from 380 nm to 750 nm.

18. The method of claim 11, wherein the DDNN component is configured to process at least one wavelength in a range from 760 nm to 1500 nm.

19. The method of claim 11, wherein the substrate comprises 3 of the one or more subsurface layers of diffractive optical elements.

20. The method of claim 19, wherein the substrate comprises 5 of the one or more subsurface layers of diffractive optical elements.
